(19) United States
(12) Patent Application Publication
(10) Pub. No.: US 2015/0118575 A1
(43) Pub. Date: Apr. 30, 2015

(54) RECHARGEABLE LITHIUM BATTERY

(71) Applicant: SAMSUNG SDI CO., LTD., Yongin-si (KR)

(72) Inventors: Tae-Hyun Bae, Yongin-si (KR); Woo-Cheol Shin, Yongin-si (KR); Sang-Hyun Eom, Yongin-si (KR); Myung-Hoon Kim, Yongin-si (KR); Seung-Tae Lee, Yongin-si (KR); Ae-Ran Kim, Yongin-si (KR); Dong-Myung Choi, Yongin-si (KR); Ha-Rim Lee, Yongin-si (KR)

(21) Appl. No.: 14/477,553

(22) Filed: Sep. 4, 2014

(30) Foreign Application Priority Data
Oct. 25, 2013 (KR) 10-2013-0128047

(51) Int. Cl. H01M 10/0567; H01M 10/058; H01M 10/052; H01M 4/38; H01M 10/0569

(52) U.S. Cl. CPC H01M 10/0567; H01M 4/386; H01M 10/0569; H01M 10/052; H01M 10/058; H01M 2220/30; H01M 2300/0028; H01M 2300/0037
USPC 429/331; 429/188; 429/342; 429/338; 429/326; 429/332; 429/199; 29/623.1

(57) ABSTRACT

A rechargeable lithium battery including a negative electrode including a negative active material, a positive electrode, and an electrolyte solution including an additive, wherein the negative active material includes a Si-based material included in an amount of about 1 to about 70 wt % based on the total amount of the negative electrode, and the additive includes fluoroethylene carbonate and a compound represented by Chemical Formula 1.

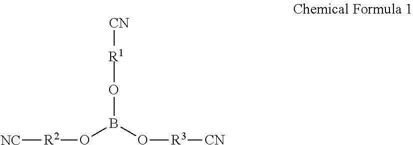

In the above Chemical Formula 1, R¹ to R³ are each independently a substituted or unsubstituted C2 to C5 alkylene group.

### CROSS-REFERENCE TO RELATED APPLICATION

This application claims priority to and the benefit of Korean Patent Application No. 10-2013-0128047 filed in the Korean Intellectual Property Office on Oct. 25, 2013, the entire content of which is incorporated herein by reference.

### BACKGROUND

1. Field

The described technology relates to a rechargeable lithium battery.

2. Description of the Related Art

A lithium polymer battery may be manufactured to have various shapes, including a thin film, and accordingly, such battery can be applied to a small IT device such as a smart phone, a tablet PC, a net book, and the like.

As these IT devices require high performance, the battery used therein requires high-capacity. However, in the rechargeable lithium battery that requires high capacity, graphite as a negative electrode material may not sufficiently realize the required high-capacity.

Accordingly, a silicon-based active material has drawn attention as a negative electrode active material, due to its higher charge and discharge capacity than that of graphite. However, the silicon-based active material has sharp cycle-life deterioration, because an electrolyte solution is exhausted due to a reaction of silicon in the negative electrode with the electrolyte solution.

### SUMMARY

Aspects of embodiments of the present invention are directed toward a rechargeable lithium battery having improved cycle-life characteristics at room temperature as well as at a high temperature during high voltage charge.

One aspect according to an embodiment is directed towards providing a rechargeable lithium battery that includes a negative electrode including a negative active material; a positive electrode including a positive active material; and an electrolyte solution including a lithium salt, an organic solvent and an additive. The negative electrode includes a current collector and a negative active material layer on the current collector and including the negative active material. The negative active material includes a Si-based material, in an amount of about 1 to about 70 wt %, and in some embodiments about 7 to about 20 wt %, based on the total amount of the negative active material layer. The additive includes fluoroethylene carbonate and a compound represented by the following Chemical Formula 1.

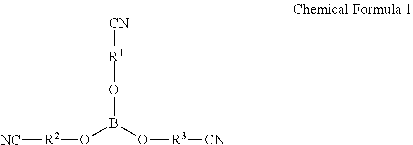

In the above Chemical Formula 1, R¹ to R³ are each independently a substituted or unsubstituted C2 to C5 alkylene group.

The compound represented by the above Chemical Formula 1 may be included in an amount of about 0.1 to about 10 parts by weight, and in some embodiments about 0.2 to about 3 parts by weight, based on 100 parts by weight of the organic solvent.

The fluoroethylene carbonate may be included in an amount of about 1 to about 15 parts by weight, and in some embodiments about 5 to about 10 parts by weight, based on 100 parts by weight of the organic solvent. In one embodiment, the fluoroethylene carbonate may be included in an amount of about 1 to about 10 parts by weight based on 100 parts by weight of the organic solvent.

The organic solvent may include linear carbonate including dimethyl carbonate, diethyl carbonate, dipropyl carbonate, methylpropyl carbonate, ethylpropyl carbonate, methylethyl carbonate, ethylmethyl carbonate, or a combination thereof; cyclic carbonate including ethylene carbonate, propylene carbonate, butylene carbonate, or a combination thereof; or a combination thereof, and in one embodiment may include propylene carbonate.

The organic solvent may include cyclic carbonate and linear carbonate in a volume ratio of about 1:1 to about 1:9.

The additive may further include LiB(C₂O₄)F₂ (lithium difluorooxalatoborate, LiFOB), and the LiB(C₂O₄)F₂ may be included in an amount of about 0.1 to about 5 parts by weight based on 100 parts by weight of the organic solvent.

The Si-based material may include Si, SiOx (0<x≦2), a Si—Y alloy (wherein Y is an element selected from an alkali metal, an alkaline-earth metal, Group 13 to 16 elements, a transition metal, a rare earth element, or a combination thereof, but is not Si), a Si—C composite, or a combination thereof.

The rechargeable lithium battery may be configured to be charged at a voltage of about 4.0 to about 4.45 V.

The compound represented by the above Chemical Formula 1 may be adapted as an anion receptor, and the anion receptor may be configured to suppress a reaction of the electrolyte solution with the Si-based material.

In one embodiment, a rechargeable lithium battery may include: a negative electrode including a negative active material; a positive electrode including a positive active material; and an electrolyte solution consisting of a lithium salt, an organic carbonate-based solvent, an additive, and byproducts formed therefrom. The additive may consist of fluoroethylene carbonate, a compound represented by Chemical Formula 1, and byproducts formed therefrom:

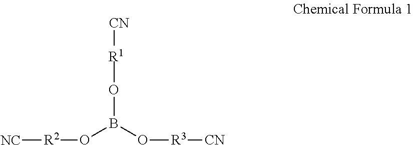

In Chemical Formula 1, R¹ to R³ selected from a substituted or unsubstituted C2 to C5 alkylene group.

In one embodiment, in the above Chemical Formula 1, R¹ to R³ are the same.

In one embodiment, a method of forming a rechargeable lithium battery includes providing a negative electrode including a negative active material; providing a positive electrode including a positive active material; and providing an electrolyte solution including a lithium salt, an organic solvent, and an additive. The negative active material may include a Si-based material, and the additive may include fluoroethylene carbonate and a compound represented by Chemical Formula 1:

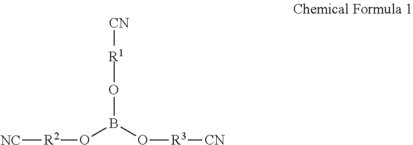

In Chemical Formula 1, R¹ to R³ are each independently a substituted or unsubstituted C2 to C5 alkylene group.

Other embodiments are included in the following detailed description.

A rechargeable lithium battery having improved cycle-life characteristics at room temperature and at a high temperature during high voltage charge may be provided.

### BRIEF DESCRIPTION OF THE DRAWINGS

The accompanying drawings, together with the specification, illustrate embodiments of the present disclosure, and, together with the description, serve to explain the principles of the present disclosure.

FIG. 1 is a schematic view showing a rechargeable lithium battery according to one embodiment.

FIG. 2 is a graph showing an XPS (X-ray photoelectron spectroscopy) analysis of the surface of the negative electrode of the rechargeable lithium battery cell according to Example 1.

FIG. 3 is a graph showing an XPS (X-ray photoelectron spectroscopy) analysis of the rechargeable lithium battery cell according to Comparative Example 1.

FIG. 4 is a graph showing a cyclic voltammetry analysis of a rechargeable lithium battery cell according to Example 1.

FIG. 5 is a graph showing a cyclic voltammetry analysis of a rechargeable lithium battery cell according to Comparative Example 1.

FIG. 6 is a graph showing room temperature cycle-life characteristics of the rechargeable lithium battery cells according to Example 1 and Comparative Example 1.

FIG. 7 is a graph showing high temperature cycle-life characteristics of the rechargeable lithium battery cells according to Examples 1 to 3 and Comparative Example 1.

### DETAILED DESCRIPTION

Hereinafter, embodiments are described in detail. However, these embodiments are exemplary, and this disclosure is not limited thereto. As those skilled in the art would recognize, the invention may be embodied in many different forms. Like reference numerals designate like elements throughout the specification. Expressions such as “at least one of” and “one of,” when preceding a list of elements, modify the entire list of elements and do not modify the individual elements of the list. Further, the use of “may” when describing embodiments of the present invention refers to “one or more embodiments of the present invention.”

As used herein, when a definition is not otherwise provided, the term “substituted” may refer to a compound in which at least one hydrogen is substituted with a substituent selected from a halogen (F, Br, Cl or I), a hydroxy group, an alkoxy group, a nitro group, a cyano group, an amino group, an azido group, an amidino group, a hydrazino group, a hydrazono group, a carbonyl group, a carbamoyl group, a thiol group, an ester group, a carboxyl group or a salt thereof, a sulfonic acid group or a salt thereof, a phosphoric acid or a salt thereof, a C1 to C20 alkyl group, a C2 to C20 alkenyl group, a C2 to C20 alkynyl group, a C6 to C30 aryl group, a C7 to C30 arylalkyl group, a C1 to C4 alkoxy group, a C1 to C20 heteroalkyl group, a C3 to C20 heteroarylalkyl group, a C3 to C30 cycloalkyl group, a C3 to C15 cycloalkenyl group, a C6 to C15 cycloalkynyl group, a C2 to C20 heterocycloalkyl group, or a combination thereof.

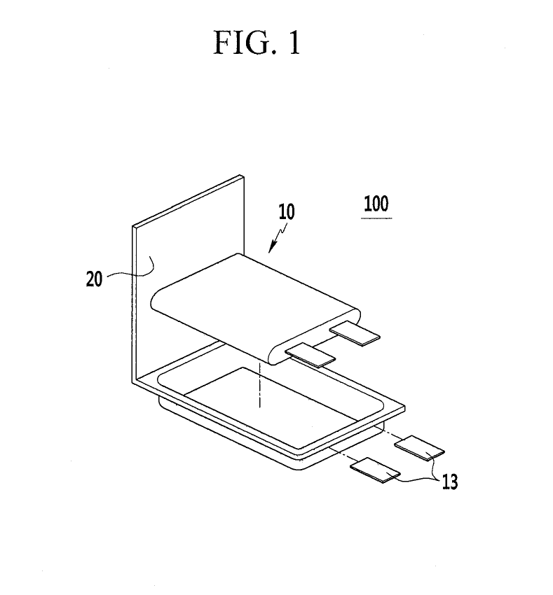

A rechargeable lithium battery according to one embodiment is described referring to FIG. 1.

FIG. 1 is a schematic view showing a rechargeable lithium battery according to one embodiment.

Referring to FIG. 1, a rechargeable lithium battery 100 according to one embodiment includes an electrode assembly 10, a battery case 20 housing the electrode assembly 10, and an electrode tab 13 playing a role of an electrical channel for externally applying or conducting a current formed in the electrode assembly 10. Two sides of the battery case 20 are coupled and sealed together. In addition, an electrolyte solution is injected into the battery case 20 housing the electrode assembly 10.

In one embodiment, the electrode assembly 10 includes a positive electrode, a negative electrode facing the positive electrode, and a separator interposed between the negative electrode and the positive electrode, and the electrolyte solution is impregnated in the positive electrode, the negative electrode and the separator.

The electrolyte solution may include a lithium salt, an organic solvent, and an additive.

The additive may include fluoroethylene carbonate and a compound represented by the following Chemical Formula 1.

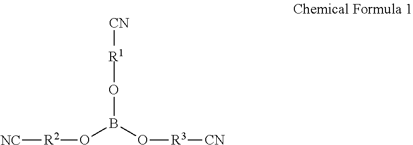

In the above Chemical Formula 1, R¹ to R³ are each independently a substituted or unsubstituted C2 to C5 alkylene group. For example, R¹ to R³ can be a C2 alkylene group or a C3 to C5 alkylene group.

In one embodiment, the compound represented by the above Chemical Formula 1 may function as an anion receptor. When added to an electrolyte solution, such compound reduces or suppresses a reaction of an electrolyte solution with a negative active material, specifically with Si-based material, and thus may improve battery performance.

Specifically, in a rechargeable lithium battery, a lithium salt of the electrolyte solution may react with the Si-based material of the negative electrode on the surface of the Si-based material according to the following reaction scheme. Here, the lithium salt is illustrated by using LiPF₆ as an example, and the Si-based material is illustrated by using SiO₂ as an example, but the lithium salt and the Si-based material are not respectively limited thereto.

LiPF₆(Li⁺+PF₆⁻)→LiF+PF₅ 1)

PF₅+H₂O→PF₃O+2HF 2)

HF+Li+e⁻→LiF+1/2H₂ 3)

2HF+Li₂CO₃→2LiF+H₂CO₃ 4)

SiO₂+4HF→SiF₄+2H₂O 5)

SiO₂+6HF→H₂SiF₆+2H₂O 6)

When the electrolyte solution reacts with the Si-based material of the negative electrode through this mechanism, it may deteriorate battery performance. In one embodiment of the present invention, when the compound represented by the above Chemical Formula 1 is bonded with an anion such as PF₆⁻, a formation of LiF in reaction 1) may be reduced or suppressed, and therefore, a decrease in the number of reversible lithium ions can be reduced or suppressed. In one embodiment, the compound represented by the above Chemical Formula 1 may dissociate the LiF even after the lithium ion becomes LiF. Accordingly, a reaction of the electrolyte solution with the Si-based material of the negative electrode can be reduced or suppressed and cycle-life characteristics of the rechargeable battery at room temperature and at high temperature may be improved.

In the above Chemical Formula 1, when the alkylene group has about 2 to about 5 carbons, the compound functions as a good anion receptor, and a reaction of the electrolyte solution with the Si-based material of the negative electrode may be reduced or suppressed.

The compound represented by the above Chemical Formula 1 may be included (or be present) in an amount of about 0.1 to about 10 parts by weight, and in some embodiments, of about 0.2 to about 3 parts by weight based on 100 parts by weight of the organic solvent. When the compound represented by the above Chemical Formula 1 is included within these ranges, the compound functions as a good anion receptor, and a reaction of the electrolyte solution with the Si-based material of the negative electrode may be reduced or suppressed.

In one embodiment, fluoroethylene carbonate is decomposed earlier than the carbonate, such as e.g. ethylene carbonate, in the organic solvent, and may form a stable Solid Electrolyte Interface (SEI) film on the surface of the negative electrode and thus, improve performance of the rechargeable lithium battery.

Fluoroethylene carbonate may be included (or be present) in an amount of about 1 to about 15 parts by weight, and in some embodiments, about 5 to about 10 parts by weight, based on 100 parts by weight of the organic solvent. In one embodiment, fluoroethylene carbonate may be included (or be present) in an amount of about 1 to about 10 parts by weight based on 100 parts by weight of the organic solvent. When fluoroethylene carbonate is included within these ranges, cycle-life characteristics of the rechargeable lithium battery may be improved at room temperature and at a high temperature without substantial capacity deterioration.

The additive may further include LiB(C₂O₄)F₂ (lithium difluorooxalatoborate, LiFOB). The LiB(C₂O₄)F₂ has small resistance against the Si-based material of the negative electrode and may further improve cycle-life characteristics at room temperature and at a high temperature.

LiB(C₂O₄)F₂ may be included (or be present) in an amount of about 0.1 to about 5 parts by weight, and in some embodiments, about 1 to about 3 parts by weight, based on 100 parts by weight of the organic solvent. When LiB(C₂O₄)F₂ is included within these ranges, cycle-life characteristics at room temperature and at a high temperature may be improved without substantial capacity deterioration.

The additive may further include vinylethylene carbonate, propane sultone, succinonitrile, adiponitrile, or a combination thereof, in addition to the additive described above.

In one embodiment, the organic solvent serves as a medium for transmitting ions taking part in the electrochemical reaction of the battery and may include linear carbonate, cyclic carbonate or a combination thereof.

The linear carbonate may include dimethyl carbonate, diethyl carbonate, dipropyl carbonate, methylpropyl carbonate, ethylpropyl carbonate, methylethyl carbonate, ethylmethyl carbonate, or a combination thereof, and the cyclic carbonate may include ethylene carbonate, propylene carbonate, butylene carbonate, or a combination thereof, but neither the linear carbonate nor the cyclic carbonate are limited thereto. In one embodiment, propylene carbonate may further improve cycle-life characteristics at room temperature and at a high temperature.

When the linear carbonate is mixed with the cyclic carbonate, a solvent having a high dielectric constant and a low viscosity may be obtained. In one embodiment, the cyclic carbonate and the linear carbonate are mixed together in a volume ratio ranging from about 1:1 to about 1:9.

The organic solvent may further include one selected from an ester-based, ether-based, ketone-based, alcohol-based solvent, or an aprotic solvent.

Non-limiting examples of the ester-based solvent include methylacetate, ethylacetate, n-propylacetate, dimethylacetate, methylpropionate, ethylpropionate, γ-butyrolactone, decanolide, valerolactone, mevalonolactone, caprolactone, or the like. Non-limiting examples of the ether solvent include dibutylether, tetraglyme, diglyme, dimethoxyethane, 2-methyltetrahydrofuran, tetrahydrofuran, or the like, and non-limiting examples of the ketone-based solvent include cyclohexanone, or the like. The alcohol-based solvent may include, for example, ethyl alcohol, isopropyl alcohol, or the like, but the alcohol-based solvent is not limited thereto.

In one embodiment, the lithium salt is dissolved in the organic solvent, supplies lithium ions in a battery, generally facilitates operation of the rechargeable lithium battery, and improves lithium ion transportation between positive and negative electrodes therein.

The lithium salt may include LiPF₆, LiBF₄, LiSbF₆, LiAsF₆, LiN(SO₃C₂F₅)₂, LiC₄F₉SO₃, LiClO₄, LiAlO₂, LiAlCl₄, LiN(CₓF₂ₓ₊₁SO₂)(C_{y}F_{2y+1}SO₂) (where x and y are natural numbers), LiCl, LiI, LiB(C₂O₄)₂ (lithium bisoxalatoborate (LiBOB)) or a combination thereof, but the lithium salt is not limited thereto.

The lithium salt may be used (or be present) in a concentration ranging from about 0.1 M to about 2.0 M. When the lithium salt is included within the above concentration range, the electrolyte may have improved performance and lithium ion mobility due to optimal (or suitable) electrolyte conductivity and viscosity.

In one embodiment, the negative electrode includes a negative current collector and a negative active material layer on the current collector.

The negative current collector may be a copper foil, a nickel foil, a stainless steel foil, a titanium foil, a nickel foam, a copper foam, a polymer substrate coated with a conductive metal, or a combination thereof, but the negative current collector is not limited thereto.

The negative active material layer may include a negative active material, a binder, and, optionally, a conductive material.

The negative active material may include a Si-based material. In one embodiment, the electrolyte solution additive described above reduces or suppresses a reaction between the Si-based material and the electrolyte solution, and thus battery performance may be improved.

The Si-based material may include Si, SiOx (0<x≦2), a Si—Y alloy (where Y is an element selected from an alkali metal, an alkaline-earth metal, Group 13 to 16 elements, transition metal, a rare earth element, or a combination thereof, but is not Si), a Si—C composite, or a combination thereof, but the Si-based material is not limited thereto. In one embodiment, Y may be selected from Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ti, Ge, P, As, Sb, Bi, S, Se, Te, Po or a combination thereof.

The Si-based material may be included (or be present) in an amount of about 1 to about 70 wt %, and in some embodiments, about 7 to about 20 wt %, based on the total amount of the negative electrode, and specifically, the negative active material layer. When the Si-based material is included within the above range, the electrolyte solution additive need not be included in a large amount, and thus high-capacity and cycle-life characteristics of the battery may be improved.

The negative active material may further include a carbon-based material, a lithium metal alloy, a transition metal oxide, or a combination thereof, in addition to the Si-based material.

The carbon-based material may include crystalline carbon, amorphous carbon, or a combination thereof, but the carbon-based material is not limited thereto. The crystalline carbon may include graphite, and non-limiting examples of graphite include non-shaped, sheet-shaped, flake-shaped, a spherical shape or fiber-shaped natural graphite or artificial graphite. The amorphous carbon may include soft carbon or hard carbon, a mesophase pitch carbonized product, fired coke, or the like.

The lithium metal alloy may be an alloy of lithium and a metal selected from Na, K, Rb, Cs, Fr, Be, Mg, Ca, Sr, Si, Sb, Pb, In, Zn, Ba, Ra, Ge, Al, or Sn, but the lithium metal alloy is not limited thereto.

The transition metal oxide may be vanadium oxide, lithium vanadium oxide, or the like, but the transition metal oxide is not limited thereto.

In one embodiment, the binder improves binding properties of negative active material particles with one another and with the current collector, and non-limiting examples of the binder include polyvinyl alcohol, carboxylmethyl cellulose, hydroxypropyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, or the like.

In one embodiment, the conductive material improves conductivity of an electrode. Any suitable electrically conductive material may be used as a conductive material, unless it causes a chemical change in the battery. Non-limiting examples of the conductive material include a carbon-based material such as natural graphite, artificial graphite, carbon black, acetylene black, ketjen black, a carbon fiber or the like; a metal-based material such as a metal powder or a metal fiber or the like of copper, nickel, aluminum, silver, or the like; a conductive polymer such as a polyphenylene derivative or the like; or a mixture thereof.

The positive electrode may include a positive current collector and a positive active material layer on the positive current collector. In one embodiment, the positive active material layer includes a positive active material, a binder, and, optionally, a conductive material.

The positive current collector may be Al (aluminum), but the positive current collector is not limited thereto.

The positive active material may be a compound capable of intercalating and deintercallating lithium. In one embodiment, at least one composite oxide of lithium and a metal such as cobalt, manganese, nickel, or a combination thereof may be utilized, and non-limiting examples of the positive active material may be a compound represented by one of the following chemical formulae:

LiₐA_{1-b}B_{b}D₂ (wherein, in the above chemical formula, 0.90≦a≦1.8 and 0≦b≦0.5); LiₐE₁₋bB_{b}O_{2-c}D_{c} (wherein, in the above chemical formula, 0.90≦a≦1.8, 0≦b≦0.5, 0≦c≦0.05); LiE_{2-b}B_{b}O_{4-c}D_{c} (wherein, in the above chemical formula, 0≦b≦0.5, 0≦c≦0.05); LiₐNi_{1-b-c}Co_{b}B_{c}D_{α} (wherein, in the above chemical formula, 0.90≦a≦1.8, 0≦b≦0.5, 0≦c≦0.05, 0<α≦2); LiₐNi_{1-b-c}Co_{b}B_{C}O_{2-α}F_{α} (wherein, in the above chemical formula, 0.90≦a≦1.8, 0≦b≦0.5, 0≦c≦0.05, 0<α<2); LiₐNi_{1-b-c}Co_{b}B_{c}O_{2-α}F₂ (wherein, in the above chemical formula, 0.90≦a≦1.8, 0≦b≦0.5, 0≦c≦0.05, 0<α<2); LiₐNi_{1-b-c}Mn_{b}B_{c}D_{α} (wherein, in the above chemical formula, 0.90≦a≦1.8, 0≦b≦0.5, 0≦c≦0.05, 0<α≦2); LiₐNi_{1-b-c}Mn_{b}B_{c}O_{2-α}F_{α} (wherein, in the above chemical formula, 0.90≦a≦1.8, 0≦b≦0.5, 0≦c≦0.05, 0<α<2); LiₐNi_{1-b-c}Mn_{b}B_{c}O_{2-α}F₂ (wherein, in the above chemical formula, 0.90≦a≦1.8, 0≦b≦0.5, 0≦c≦0.05, 0<α<2); LiₐNi_{b}E_{c}G_{d}O₂ (wherein, in the above chemical formula, 0.90≦a≦1.8, 0≦b≦0.9, 0≦c≦0.5, 0.001≦d≦0.1); LiₐNi_{b}Co_{c}Mn_{d}GₑO₂ (wherein, in the above chemical formula, 0.90≦a≦1.8, 0≦b≦0.9, 0≦c≦0.5, 0≦d≦0.5, 0.001≦e≦0.1); LiₐNiG_{b}O₂ (wherein, in the above chemical formula, 0.90≦a≦1.8, 0.001≦b≦0.1); LiₐCoG_{b}O₂ (wherein, in the above chemical formula, 0.90≦a≦1.8, 0.001≦b≦0.1); LiₐMnG_{b}O₂ (wherein, in the above chemical formula, 0.90≦a≦1.8, 0.001≦b≦0.1); LiₐMn₂G_{b}O₄ (wherein, in the above chemical formula, 0.90≦a≦1.8, 0.001≦b≦0.1); QO₂; QS₂; LiQS₂; V₂O₅; LiV₂O₅; LiIO₂; LiNiVO₄; Li_{(3-f)}J₂(PO₄)₃ (0≦f≦2); Li_{(3-f)}Fe₂(PO₄)₃(0≦f≦2); or LiFePO₄.

In the above chemical formulae, A is Ni, Co, Mn, or a combination thereof; B is Al, Ni, Co, Mn, Cr, Fe, Mg, Sr, V, a rare earth element, or a combination thereof; D is O, F, S, P, or a combination thereof; E is Co, Mn, or a combination thereof; F is F, S, P, or a combination thereof; G is Al, Cr, Mn, Fe, Mg, La, Ce, Sr, V, or a combination thereof; Q is Ti, Mo, Mn, or a combination thereof; I is Cr, V, Fe, Sc, Y, or a combination thereof; and J is V, Cr, Mn, Co, Ni, Cu, or a combination thereof.

In one embodiment, the positive active material may be lithium cobalt oxide, lithium nickel cobalt manganese oxide, lithium nickel cobalt aluminum oxide, or a combination thereof.

In one embodiment, the binder improves binding properties of positive active material particles with one another and with the current collector, and non-limiting examples of the binder include polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, or the like.

In one embodiment, the conductive material improves conductivity of an electrode. Any suitable electrically conductive material may be used as a conductive material, unless it causes a chemical change in the battery. Non-limiting examples of the conductive material include natural graphite, artificial graphite, carbon black, acetylene black, ketjen black, a carbon fiber, copper, a metal powder, a metal fiber or the like of nickel, aluminum, silver, or the like, or a conductive material such as a polyphenylene derivative or the like, or a combination thereof.

The negative electrode and the positive electrode may be each manufactured by a method including mixing the respective active material, conductive material, and binder to prepare an active material composition and coating the composition on a current collector. The electrode manufacturing method should be apparent to those of skill in the art and thus, the method is not described in more detail here. The solvent can include N-methylpyrrolidone or the like, but the solvent not limited thereto.

The separator may include any suitable materials, as long as the materials are capable of separating the negative electrode from the positive electrode and providing a transporting passage for lithium ions. In other words, the separator may have a low resistance to ion transportation and an excellent impregnation with respect to an electrolyte solution. In one embodiment, the separator may be selected from a glass fiber, polyester, polyethylene, polypropylene, polytetrafluoroethylene (PTFE), or a combination thereof, but the separator is not limited thereto. It may have a form of a non-woven fabric or a woven fabric. For example, a polyolefin-based polymer separator such as polyethylene, polypropylene or the like is often included in a lithium ion battery. In order to ensure (or provide) heat resistance and mechanical strength, a coated separator including a ceramic component or a polymer material may be utilized. In one embodiment, the separator may have a mono-layered or multi-layered structure.

The rechargeable lithium battery according to one embodiment may be charged at a high voltage of about 4.0 to about 4.45 V. Even though the rechargeable lithium battery is charged within the high voltage range, excellent cycle-life characteristics at room temperature and a high temperature may be secured.

Hereinafter, the embodiments are illustrated in more detail with reference to examples. However, these examples are exemplary, and the present disclosure is not limited thereto.

Furthermore, what is not described in this disclosure will be readily understood by those of skill in the art and, therefore, will not be described in more detail.

### Example 1

### Manufacture of Positive Electrode

A positive active material layer composition was prepared by mixing 80 wt % of LiCoO₂ and 20 wt % of LiNi_{0.5}Co_{0.2}Mn_{0.3}O₂, polyvinylidene fluoride (PVdF), and carbon black in a weight ratio of 92:4:4 and dispersing the obtained mixture in N-methyl-2-pyrrolidone. The positive active material layer composition was coated on a 20 μm-thick aluminum foil, dried, and compressed, manufacturing a positive electrode.

### Manufacture of Negative Electrode

A negative active material layer composition was prepared by mixing 90 wt % of graphite and Si alloy (CV4, 3M) and polyvinylidene fluoride (PVdF) in a weight ratio of 92:8 and dispersing the resulting mixture in N-methyl-2-pyrrolidone. The negative active material layer composition was coated on a 15 μm-thick copper foil, dried, and compressed, manufacturing a negative electrode.

### Preparation of Electrolyte Solution

An electrolyte solution was prepared by mixing ethylene carbonate (EC), ethylmethyl carbonate (EMC), and diethyl carbonate (DEC) in a volume ratio of 3:5:2 to prepare a mixed solvent, dissolving 1.3 M LiPF₆ in the mixed solvent, and adding 10 parts by weight of fluoroethylene carbonate and 0.2 parts by weight of a compound represented by the following Chemical Formula 2 based on 100 parts by weight of the mixed solvent to the solution.

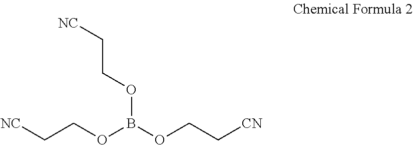 [SMILES: N#CCCOB(OCCC#N)OCCC#N]

### Manufacture of Rechargeable Lithium Battery Cell

The positive electrode and the negative electrode, along with an 18 μm-thick polyethylene separator, were spirally wound, manufacturing an electrode assembly. Subsequently, the electrode assembly was put in a battery case, and the electrolyte solution was inserted into the battery case, manufacturing a rechargeable lithium battery cell.

### Example 2

A rechargeable lithium battery cell was manufactured as in Example 1 except for preparing the electrolyte solution by using a mixed solvent of ethylene carbonate (EC), propylene carbonate (PC) and diethyl carbonate (DEC) at a volume ratio of 2:2:6.

### Example 3

A rechargeable lithium battery cell was manufactured as in Example 2 except for preparing the electrolyte solution by adding 3 parts by weight of LiB(C₂O₄)F₂ based on 100 parts by weight of the mixed solvent.

### Comparative Example 1

A rechargeable lithium battery cell was manufactured as in Example 1 except for not adding the compound represented by the above Chemical Formula 2.

### Evaluation 1: XPS Analysis of Rechargeable Lithium Battery Cell

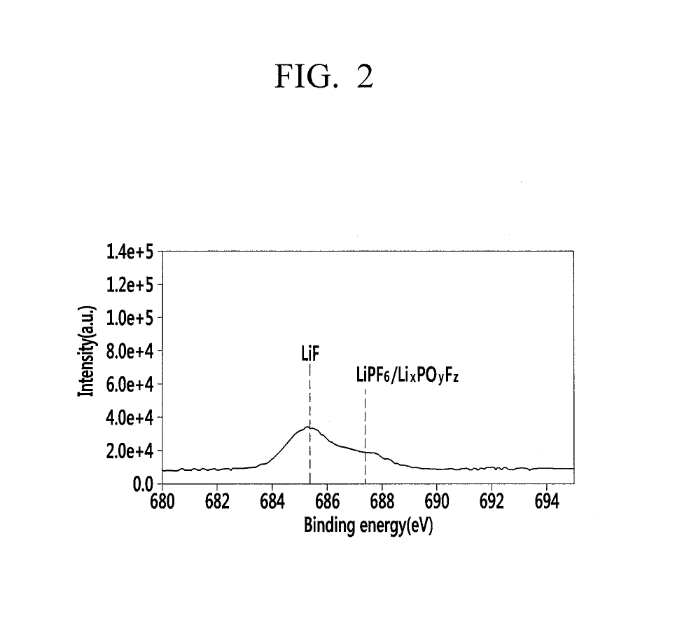

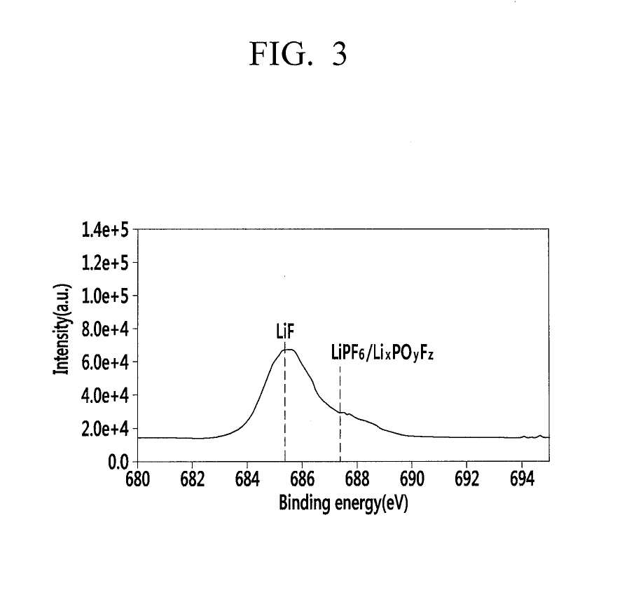

XPS (X-ray photoelectron spectroscopy) analyses for the rechargeable lithium battery cells according to Example 1 and Comparative Example 1 were carried out, and the results are shown in FIGS. 2 and 3.

FIG. 2 is a graph showing an XPS (X-ray photoelectron spectroscopy) analysis of the surface of the negative electrode of the rechargeable lithium battery cell according to Example 1, and FIG. 3 is a graph showing an XPS (X-ray photoelectron spectroscopy) analysis of the rechargeable lithium battery cell according to Comparative Example 1.

Referring to FIGS. 2 and 3, a LiF content of Example 1 is lower relative to that of Comparative Example 1, because in the rechargeable battery according to Example 1, the compound represented by Chemical Formula 1, as an electrolyte solution additive, functions as an anion receptor and suppresses (or reduces) a reaction of lithium ion into LiF, and accordingly a reaction of the Si-based material of the negative electrode with the electrolyte solution may be suppressed (or reduced).

### Evaluation 2: Irreversible Characteristic of Negative Electrode

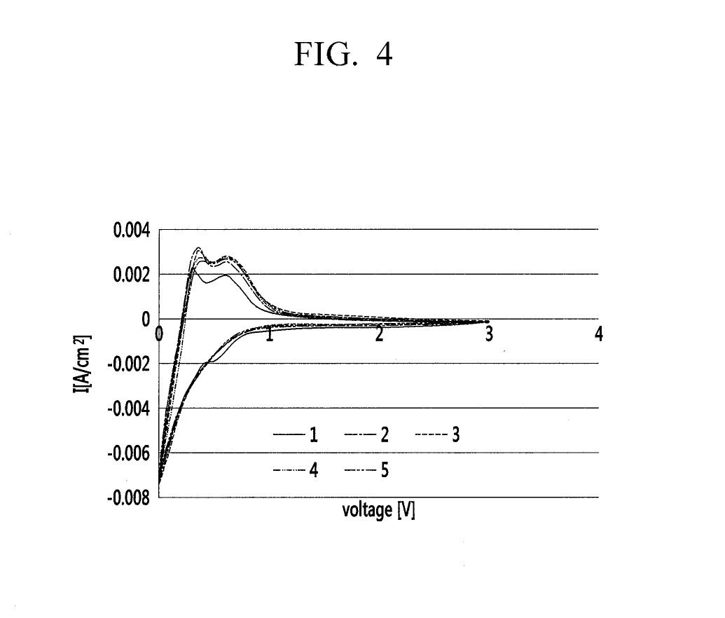

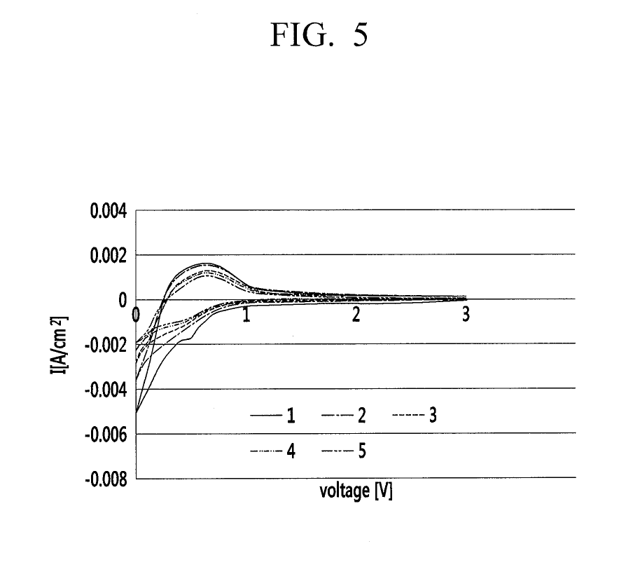

Irreversible characteristics of the negative electrodes of Example 1 and Comparative Example 1 were evaluated using a negative electrode as a working electrode and a lithium metal as a reference electrode and a counter electrode, and performing a cyclic voltammetry analysis from 0V to 3V at a speed of 1 mV/s, and the results are illustrated in FIGS. 4 and 5.

FIG. 4 is a graph showing a cyclic voltammetry analysis of a rechargeable lithium battery cell according to Example 1, and FIG. 5 is a graph showing a cyclic voltammetry analysis of a rechargeable lithium battery cell according to Comparative Example 1.

Referring to FIGS. 4 and 5, FIG. 5 shows that a current peak in an area ranging from about 0V to 1V decreases as a cycle goes, and FIG. 4 shows that that the current peak disappears away as a cycle goes. Accordingly, the rechargeable lithium battery cell of Example 1 in FIG. 4 showed more reversible lithium ion Example 1 than that of Comparative Example 1 in FIG. 5.

### Evaluation 3: Cycle-Life Characteristics of Rechargeable Lithium Battery Cell

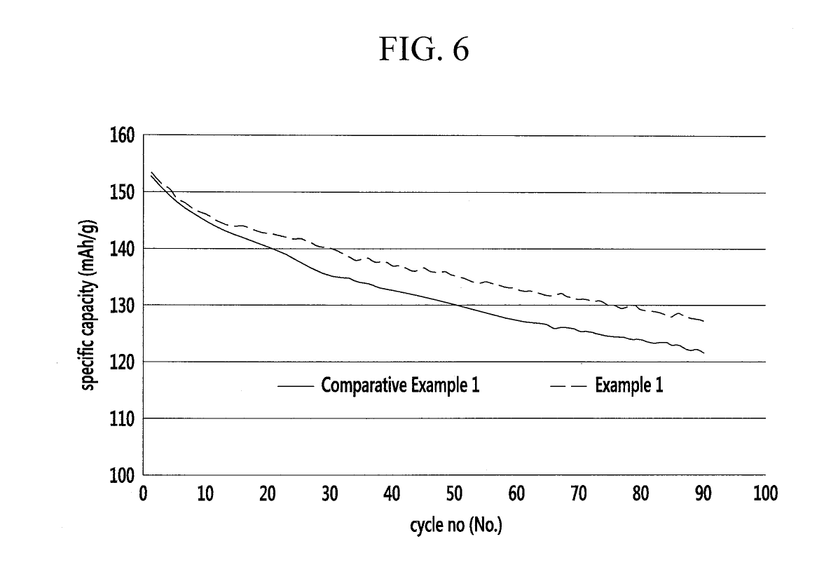

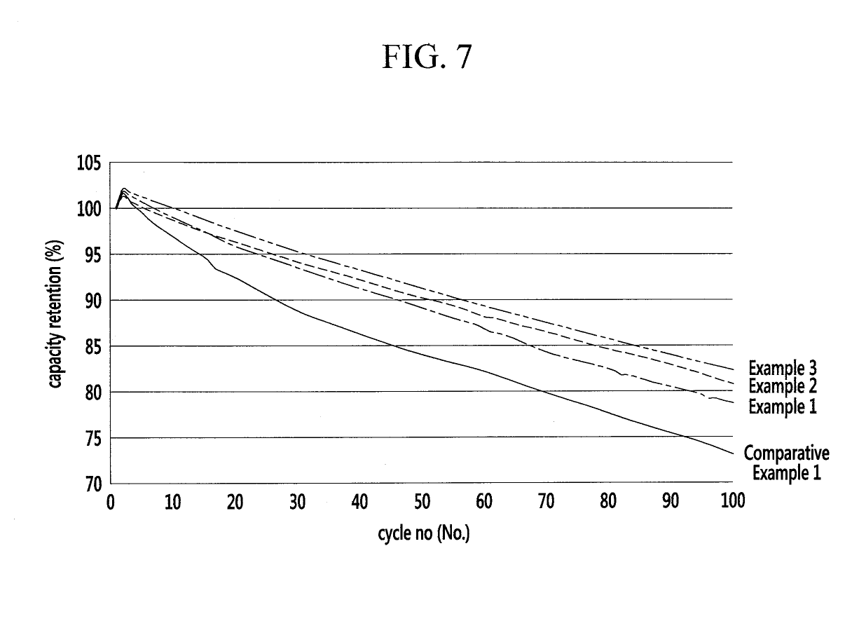

The rechargeable lithium battery cells according to Examples 1 to 3 and Comparative Example 1 were charged at 4.4V and 0.7C at room temperature and 45° C., respectively, and then discharged at 2.75V and 0.5C, and discharge capacity of the rechargeable lithium battery cells depending on a cycle was evaluated after 100 times repeating this charge and discharge, and the results are provided in FIGS. 6 and 7.

FIG. 6 is a graph showing room temperature cycle-life characteristics of the rechargeable lithium battery cells according to Example 1 and Comparative Example 1.

Referring to FIG. 6, the rechargeable lithium battery cell according to Example 1, where fluoroethylene carbonate and the compound represented by Chemical Formula 2 were added to the electrolyte solution, showed improved cycle-life characteristics at room temperature, compared with the rechargeable lithium battery cell according to Comparative Example 1, where the compound represented by the above Chemical Formula 2 was not added.

FIG. 7 is a graph showing high temperature cycle-life characteristics of the rechargeable lithium battery cells according to Examples 1 to 3 and Comparative Example 1.

Referring to FIG. 7, the rechargeable lithium battery cells according to Examples 1 to 3, where fluoroethylene carbonate and the compound represented by Chemical Formula 2 were added in the electrolyte solution, showed improved cycle-life characteristics at high temperature, compared with the rechargeable lithium battery cell according to Comparative Example 1, where the compound represented by the above Chemical Formula 2 was not added.

In the rechargeable lithium battery cells according to Examples 1 to 3, improvement of high temperature cycle-life characteristics due to adding fluoroethylene carbonate and the compound represented by Chemical Formula 1 to the electrolyte solution, may be further realized when the propylene carbonate solvent is utilized, and may be even better realized when LiFOB is included along with the propylene carbonate solvent.

While this disclosure has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims and equivalents thereof.

### DESCRIPTION OF SYMBOLS

100: rechargeable lithium battery
10: electrode assembly
20: battery case
13: electrode tab

What is claimed is:

1. A rechargeable lithium battery comprising
a negative electrode comprising a negative active material;
a positive electrode comprising a positive active material; and
an electrolyte solution comprising a lithium salt, an organic solvent, and an additive, wherein the negative active material comprises a Si-based material, and
the additive comprises fluoroethylene carbonate and a compound represented by Chemical Formula 1: 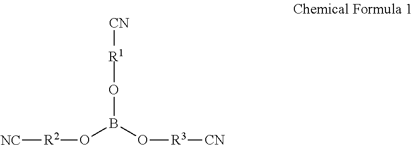
wherein, in Chemical Formula 1, R¹ to R³ are each independently a substituted or unsubstituted C2 to C5 alkylene group.

2. The rechargeable lithium battery of claim 1, wherein the negative electrode comprises a current collector and a negative active material layer on the current collector, the negative active material layer comprising the negative active material, and
wherein the Si-based material is in an amount of about 1 to about 70 wt % based on the total amount of the negative active material layer.

3. The rechargeable lithium battery of claim 2, wherein the Si-based material is in the amount of about 7 to about 20 wt % based on the total amount of the negative active material layer.

4. The rechargeable lithium battery of claim 1, wherein the compound represented by Chemical Formula 1 is in the electrolyte solution in an amount of about 0.1 to about 10 parts by weight based on 100 parts by weight of the organic solvent.

5. The rechargeable lithium battery of claim 4, wherein the compound represented by Chemical Formula 1 is in the electrolyte solution in the amount of about 0.2 to about 3 parts by weight based on 100 parts by weight of the organic solvent.

6. The rechargeable lithium battery of claim 1, wherein fluoroethylene carbonate is in the electrolyte solution in an amount of about 1 to about 15 parts by weight based on 100 parts by weight of the organic solvent.

7. The rechargeable lithium battery of claim 6, wherein fluoroethylene carbonate is in the electrolyte solution in the amount of about 5 to about 10 parts by weight based on 100 parts by weight of the organic solvent.

8. The rechargeable lithium battery of claim 1, wherein the organic solvent comprises linear carbonate selected from the group consisting of dimethyl carbonate, diethyl carbonate, dipropyl carbonate, methylpropyl carbonate, ethylpropyl carbonate, methylethyl carbonate, ethylmethyl carbonate, and combinations thereof; cyclic carbonate selected from the group consisting of ethylene carbonate, propylene carbonate, butylene carbonate, and combinations thereof; or a combination thereof.

9. The rechargeable lithium battery of claim 8, wherein the organic solvent comprises propylene carbonate.

10. The rechargeable lithium battery of claim 1, wherein the organic solvent comprises cyclic carbonate and linear carbonate, and
wherein the cyclic carbonate and the linear carbonate are in a volume ratio of about 1:1 to about 1:9.

11. The rechargeable lithium battery of claim 1, wherein the additive further comprises LiB(C₂O₄)F₂.

12. The rechargeable lithium battery of claim 11, wherein LiB(C₂O₄)F₂ is in the electrolyte solution in an amount of about 0.1 to about 5 parts by weight based on 100 parts by weight of the organic solvent.

13. The rechargeable lithium battery of claim 1, wherein the Si-based material comprises Si; SiOx where 0<x≦2; a Si—Y alloy where Y is an element selected from the group consisting of an alkali metal, an alkaline-earth metal, Group 13 to 16 elements, a transition metal, a rare earth element, and combinations thereof, but not Si; a Si—C composite; or a combination thereof.

14. The rechargeable lithium battery of claim 1, wherein the rechargeable lithium battery is configured to be charged at a voltage of about 4.0 to about 4.45 V.

15. The rechargeable lithium battery of claim 1, wherein the compound represented by Chemical Formula 1 is adapted as an anion receptor.

16. The rechargeable lithium battery of claim 15, wherein the anion receptor is configured to suppress a reaction of the electrolyte solution with the Si-based material.

17. A rechargeable lithium battery comprising:
a negative electrode comprising a negative active material;
a positive electrode comprising a positive active material; and
an electrolyte solution consisting of a lithium salt, an organic carbonate-based solvent, an additive, and byproducts formed therefrom,
wherein the additive consists of fluoroethylene carbonate, a compound represented by Chemical Formula 1, and byproducts formed therefrom: 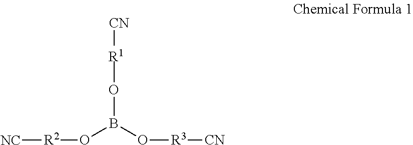
wherein, in Chemical Formula 1, R¹ to R³ selected from a substituted or unsubstituted C2 to C5 alkylene group.

18. The rechargeable lithium battery of claim 17, wherein R¹ to R³ are the same.

19. The rechargeable lithium battery of claim 17, wherein the organic solvent consists of cyclic carbonate and linear carbonate, and
wherein the cyclic carbonate and the linear carbonate are in a volume ratio of about 1:1 to about 1:9.

20. A method of forming a rechargeable lithium battery, the method comprising:
providing a negative electrode comprising a negative active material;
providing a positive electrode comprising a positive active material; and
providing an electrolyte solution comprising a lithium salt, an organic solvent, and an additive,
wherein the providing of the negative electrode comprises providing the negative active material to include a Si-based material, and
the providing of the electrolyte solution comprises providing the additive to include fluoroethylene carbonate and a compound represented by Chemical Formula 1: 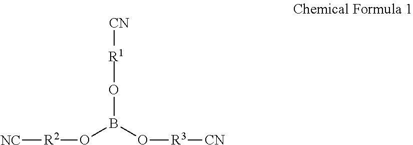
wherein, in Chemical Formula 1, R¹ to R³ are each independently a substituted or unsubstituted C2 to C5 alkylene group.
